(19) United States
(12) Patent Application Publication
(10) Pub. No.: US 2008/0137504 A1
(43) Pub. Date: Jun. 12, 2008

(54) Method Of Writing Data On A Master Substrate For Optical Recording

(75) Inventors: Erwin Rinaldo Meinders, Eindhoven (NL); Rolf Antonie Loch, Enshede (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,037

(22) PCT Filed: Oct. 12, 2005
(86) PCT No.: PCT/IB05/53351

§ 371 Date: Apr. 11, 2007

(30) Foreign Application Priority Data
Oct. 19, 2004 (EP) 04105150.9

(51) Int. Cl. G11B 7/125

(52) U.S. Cl. 369/59.12

(57) ABSTRACT

The present invention relates to a method of writing data on a master substrate (10) for optical recording, the master substrate comprising a recording layer (12) and a substrate layer (14), and the recording layer comprising a phase-change material the phase of which can be transferred from crystalline to amorphous by projecting light on the recording 5 layer, the method comprising the steps of: writing a first amorphous mark (32) from a plurality of amorphous marks on the master substrate by at least one write pulse, and providing a cooling gap before the next amorphous mark (32) will be written.

### FIELD OF THE INVENTION

The present invention relates to a method of writing data on a master substrate for optical recording.

### BACKGROUND OF THE INVENTION

Relief structures that are manufactured on the basis of optical processes can, for example, be used as a stamper for the mass-replication of optical record carriers. Optical record carriers have seen an evolutionary increase in the data capacity by increasing the numerical aperture of the objective lens and a reduction of he laser wavelength. The total data capacity was increased from 650 Mbyte (CD, NA=0.45, λ=780 nm) to 4.7 Gbyte (DVD, NA=0.65, λ=670 nm) to 25 Gbyte for the Blu-ray Disc (BD, NA=0.85, λ=405 nm). Optical record carriers can be of the type write-once (R), rewritable (RE) and read-only memory (ROM). The great advantage of ROM discs is the cheap mass replication, and therefore the cheap distribution of content such as audio, video and other data. Such a ROM disc is, for example, a polycarbonate substrate with tiny replicated pits (holes). The pits in a ROM disc can be made with injection molding or a similar kind of replication process. The manufacturing of a stamper, as used for replication, is known as mastering.

ROM discs contain a spiral of alternating pits and lands representing the encoded data. A reflection layer (metallic or other kind or material with different index of refraction coefficient) is added to facilitate the readout of the information. In most of the optical recording systems, the data track pitch has the same order of magnitude as the size of the optical readout/write spot to ensure optimum data capacity. Compare for example the data track pitch of 320 nm and the 1/e spot radius of 305 nm (1/e is the radius at which the optical intensity has reduced to 1/e of the maximum intensity) in case of Blu-ray Disc. In contrary to write-once and re-writable optical record carriers, the pit width in a ROM disc is typically half of the pitch between adjacent data tracks. Such small pits are necessary for optimum readout. It is well known that ROM discs are readout via phase-modulation, i.e. the constructive and destructive interference of light rays. During readout of longer pits, destructive interference between light rays reflected from the pit bottom and reflected form the adjacent land plateau occurs, which leads to a lower reflection level.

In conventional mastering, a thin photosensitive layer, spincoated on a glass substrate, is illuminated with a modulated focused laser beam. The modulation of the laser beam causes that some parts of the disc are being exposed by UV light while the intermediate areas in between the pits remain unexposed. While the disc rotates, and the focused laser beam is gradually pulled to the outer side of the disc, a spiral of alternating illuminated areas remains. In a second step, the exposed areas are being dissolved in a so-called development process to end up with physical holes inside the photo-resist layer. Alkaline liquids such as NaOH and KOH are used to dissolve the exposed areas. The structured surface is subsequently covered with a thin Ni layer. In a galvanic process, this sputter-deposited Ni layer is further grown to a thick manageable Ni substrate with the inverse pit structure. This Ni substrate with protruding bumps is separated from the substrate with unexposed areas and is called the stamper.

To make pits of approximately half the optical readout spot, a laser with a lower wavelength than used for readout is typically used for mastering of the pit structure. For CD/DVD mastering, the Laser Beam Recorder (LBR) typically operates at a wavelength of 413 nm and numerical aperture of the objective lens of NA=0.9. For BD mastering, a deep UV laser with 257 nm wavelength is used in combination with a high NA lens (0.9 for far-field and 1.25 for liquid immersion mastering). In other words, a next generation LBR is required to make a stamper for the current optical disc generation. An additional disadvantage of conventional photoresist mastering is the cumulative photon effect. The degradation of the photo-sensitive compound in the photoresist layer is proportional to the amount of illumination. The sides of the focused Airy spot also illuminates the adjacent traces during writing of pits in the central track. This multiple exposure leads to local broadening of the pits and therefore to an increased pit noise (jitter). Also for reduction of cross-illumination, an as small as possible focused laser spot is required. Another disadvantage of photoresist materials as used in conventional mastering is the length of the polymer chains present in the photoresist. Dissolution of the exposed areas leads to rather rough side edges due to the long polymer chains. In particular in case of pits (for ROM) and grooves (for pre-grooved substrates for write-once (R) and rewritable (RE) applications) this edge roughness may lead to deterioration of the readout signals of the pre-recorded ROM pits and recorded R/RE data.

Phase-transition mastering was proposed to overcome the cummulation effect caused by a second exposure of the central track due to writing in the adjacent track (one revelation later). In phase-transition mastering, laser-induced heating is utilized to write a different phase in the recording material. The initial unwritten state of the material is different than the written state. One of the two states, either the initial unwritten or the written phase, dissolves faster in developer liquids, like alkaline liquids (NaOH and KOH) and acids (HCl or HNO3) such that a relief structure remains after developing. Several recording materials possess this selective etching behaviour, such as SbTe compositions. Another difference with conventional photoresist mastering is the possibility to directly read the written data. This allows for a fast feedback and thus to adapt the writing parameters (such as laser power) to the actual state of writing. Both the avoidance of the cumulative effect and the possibility to control the laser power via a feedback mechanism of the recorded data, enable the use of a braoder laser spot. In other words, BD density (25 GB on a 120 mm disc) can be written with a Laser Beam Recorder based on a 405 nm blue laser diode and a numerical aperure of NA=0.9.

To achieve an as high as possible data density, both the tangential density, expressed in the channel bit length, and the radial density, determined by the data track pitch, needs to be optimized with respect to the system parameters. A reduction of the data track pitch is accompanied by thermal cross-write, i.e. the degradation of the data written in the adjacent track due to writing data in the central track.

It is an object of the invention to provide a method of writing data on a master substrate so that thermal cross-write is reduced.

### SUMMARY OF THE INVENTION

The above objects are solved by the features of the independent claims. Further developments and preferred embodiments of the invention are outlined in the dependent claims.

In accordance with the invention, there is provided a method of writing data on a master substrate for optical recording, the master substrate comprising a recording layer and a substrate layer, and the recording layer comprising a phase-change material the phase of which can be transferred from crystalline to amorphous by projecting light on the recording layer, the method comprising the steps of:

writing a first amorphous mark from a plurality of amorphous marks on the master substrate by at least one write pulse, and

providing a cooling gap before the next amorphous mark will be written.

Phase-change materials are applied in the well-known re-writable disc formats, such as DVD+RW and the recently introduced Blu-Ray Disc (BD-RE). Phase-change materials can change from the as-deposited amorphous state to the crystalline state via laser heating. In many cases, the as-deposited amorphous state is made crystalline prior to recording of data. The initial crystalline state can be made amorphous by laser induced heating of the thin phase-change layer such that the layer melts. If the molten state is very rapidly cooled down, a solid amorphous state remains. The amorphous mark (area) can be made crystalline again by heating the amorphous mark to above the crystallisation temperature. These mechanisms are known from rewritable phase-change recording. The applicants have found that, depending on the heating conditions, a difference in etch velocity exists between the crystalline and amorphous phase. Etching is known as the dissolution process of a solid material in an alkaline liquid, acid liquid, or other type or solvent. The difference in etch velocity leads to a relief structure. Suitable etching liquids for the claimed material classes are alkaline liquids, such as NaOH, KOH and acids, such as HCl and HNO₃. The relief structure can, for example, be used to make a stamper for the mass replication of optical read-only ROM discs and possibly pre-grooved substrates for write-once and rewritable discs. The obtained relief structure can also be used for high-density printing of displays (micro-contact printing). The phase-change material for use as recording material is selected based on the optical and thermal properties of the material such that it is suitable for recording using the selected wavelength. In case the master substrate is initially in the amorphous state, crystalline marks are recorded during illumination. In case the recording layer is initially in the crystalline state, amorphous marks are recorded. During developing, one of the two states is dissolved in the alkaline or acid liquid to result in a relief structure. Phase-change compositions can be classified into nucleation-dominated and growth-dominated materials. Nucleation-dominated phase-change materials have a relative high probability to form stable crystalline nuclei from which crystalline marks can be formed. On the contrary, the crystallisation speed is typically low. Examples of nucleation-dominated materials are Ge₁Sb₂Te₄ and Ge₂Sb₂Te₅ materials. Growth-dominated materials are characterized by a low nucleation probability and a high growth rate. Examples of growth-dominated phase-change compositions are compositions Sb₂Te doped with In and Ge and SnGeSb alloys. In case crystalline marks are written in an initial amorphous layer, typical marks remain that are conform the shape of the focused laser spot. The size of the crystalline mark can somewhat be tuned by controlling the applied laser power, but the written mark Can hardly be made smaller than the optical spot. In case amorphous marks are written in a crystalline layer, the crystallisation properties of the phase-change material allow for a mark that is smaller than the optical spot size. In particular in case growth-dominated phase-change materials are used, re-crystallisation in the tail of the amorphous mark can be induced by application of proper laser levels at proper time scales relative to the time at which the amorphous mark is written. This re-crystallisation enables the writing of marks smaller than the optical spot size. The recording materials used in the present invention are preferably fast-growth phase-change materials, preferably of the composition: SnGeSb (Sn_{18.3}—Ge_{12.6}—Sb_{69.2} (At %)) or Sb₂Te doped with In Ge etc, such as InGeSbTe. The recording layer thickness is between 5 and 80 nm, preferably between 10 and 40 nm. Write strategies known from rewritable phase-change recording contain pulse trains to write amorphous marks and intermediate erase periods to write the crystalline spaces in between the marks. The function of the erase level is twofold: the old amorphous data need to be erased and the tail of the mark is shaped via re-crystallization induced by the erase plateau. A cooling gap is typically provided between the last write pulse of the pulse trail and the erase period to enable the melt-quenching. The present invention takes advantage of the experiences made with such systems and proposes a generic write strategy for writing a high-density data pattern in a record master that is based on fast-growth phase-change materials, and that is developed via etching to a high-density relief structure. The proposed write strategy suppresses heat accumulation during write of the amorphous marks and prevents noticeable thermal cross-write of marks in adjacent racks while enabling a controlled re-crystallization in the tail of the mark.

Preferably, a plurality of write pulses is used for writing an amorphous mark, the write pulses having essentially the same power. Such a pulse train with several write pulses of identical power is useful in order to write an amorphous mark without depositing too much heat within the record carrier. On the basis of a plurality of write marks, different write strategies can be provided. The choice of identical power for all write pulses can particularly be made, when no special requirements as to the leading and trailing edges of the write marks are present.

It can also be useful, if a plurality of write pulses is used for writing an amorphous mark, the write pulses having different power values. Particularly the first and the last write pulse of such a pulse train can have a higher writing power than the write pulses in between. Thereby, the leading and trailing edges of the amorphous marks can be influenced.

According to a preferred embodiment of the present invention it is considered that, after the at least one write pulse, at least one erase pulse is applied, the erase pulse having a power less than the write pulse. Thereby a particular useful shaping of the trailing edge of the amorphous mark can be achieved. By the application of an erase pulse, re-crystallization of the previously written amorphous region can be obtained, without depositing too much power in the record carrier.

Particularly, an erase pulse following a larger number of write pulses has a lower power than an erase pulse following a smaller number of write pulses. In case that a longer mark is written, the deposited thermal energy is higher than in the case of a short mark. Thus, it is possible to provide an erase pulse with higher power after a short pulse without unduly increasing the thermal energy totally deposited.

According to one of the write strategies according to the present invention, a mark having a length of N times the channel bit length T is written by N write pulses. Thereby, a basic write strategy is provided which is, however, not preferred with low recording velocity due to the tendency of increase re-crystallization over a large region of the written marks.

This problem can be avoided on the basis of a write strategy in which a mark having a length of N times the channel bit length T is written by N−1 write pulses. Due to the wider cooling gaps between the write pulses, the re-crystallization during writing is reduced. According to another preferred strategy, a mark having a length of N times the channel bit length T is written by N/2 write pulses. This preferred embodiment reduces the heat accumulation in the recording stack and, therefore, suppresses re-crystallization during writing.

According to a further preferred embodiment, the first write pulse from a plurality of write pulses is the longest write pulse. An extension of the first write pulse will lead to a better defined leading edge of the recorded mark. The length and the power of the subsequent pulses may be varied to minimize re-crystallization during writing.

According to a particularly preferable embodiment, cooling gaps of adjustable lengths are provided between write pulses belonging to the same amorphous mark. Furthermore, a cooling gap of adjustable length is provided before the erase pulse.

Thus, on the basis of the present invention, a number of parameters for optimizing the write strategy are provided, in particular:
The number of pulses with which a mark is written;
The duration of the write pulses, which has to be considered in connection with the recording velocity (typically between 2 and 10 m/s, however, depending on the used phase-change material);
The power of each write pulse;
The length of the cooling gaps in between the write pulses;
The power of the erase bumps, typically between 0.2 and 0.7 times the write power;
The duration of the erase bumps, typically between 0.5 and 2.5 times the write pulse duration.

These and other aspects of the invention will be apparent from and elucidated with reference to the embodiments described hereinafter.

### BRIEF DESCRIPTION OF THE DRAWINGS

FIG. 1 shows a schematic set-up of a conventional optical disc drive that can be employed with the present invention;

FIG. 2 shows a schematic cross section through a master substrate for being processed according to the present invention;

FIG. 3 shows a schematic cross section through a further embodiment of a master substrate after partly being processed according to the present invention;

FIG. 4 shows a schematic cross section through a master substrate after a further processing step;

FIG. 5 shows a pulse diagram for illustrating an embodiment according to the present invention;

FIG. 6 shows a temperature-time diagram for explaining the thermal cross-write effect;

FIG. 7 shows model calculations for illustrating the controlled re-crystallization;

FIG. 8 shows a pulse diagram for illustrating an embodiment of the present invention;

FIG. 9 shows pictures from an atomic force microscope (AFM pictures) of a data patterns;

FIG. 10 shows a pulse diagram for illustrating an embodiment according to the present invention;

FIG. 11 shows pictures from an atomic force microscope;

FIG. 12 shows a pulse diagram for illustrating an embodiment according to the present invention;

FIG. 13 shows pictures from an atomic force microscope;

FIG. 14 shows a pulse diagram for illustrating an embodiment according to the present invention;

FIG. 15 shows pictures from an atomic force microscope;

FIG. 16 shows a pulse diagram for illustrating an embodiment according to the present invention;

FIG. 17 shows a pulse diagram for illustrating an embodiment according to the present invention;

FIG. 18 shows a further pulse diagram for illustrating an embodiment according to the present invention;

FIG. 19 shows pictures from an atomic force microscope.

### DESCRIPTION OF PREFERRED EMBODIMENTS

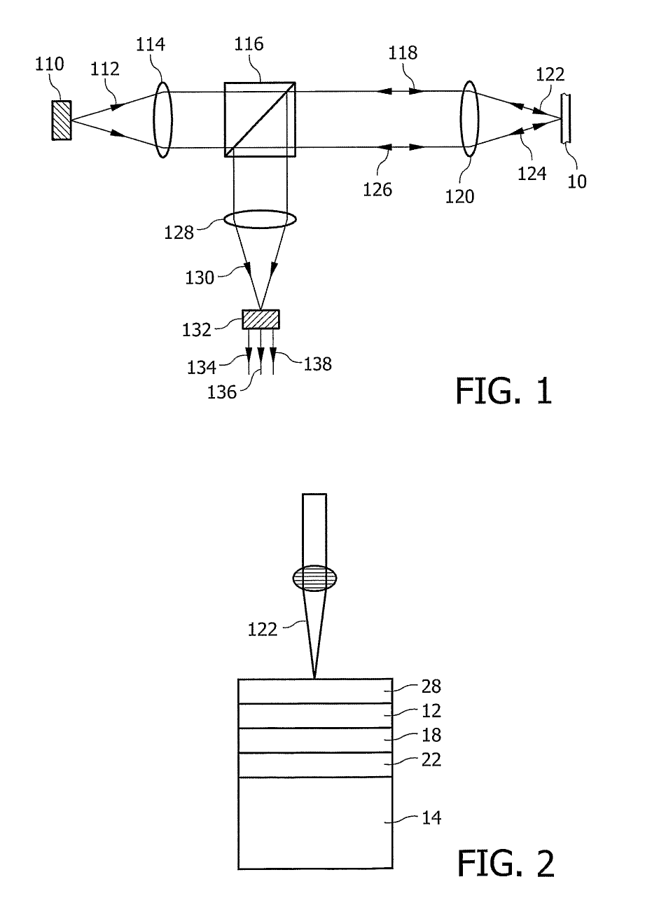

FIG. 1 shows a schematic set-up of a conventional optical disc drive that can be employed with the present invention. Although the setup is described on the basis of a conventional optical disc drive and a pre-grooved substrate, the present invention can also be employed with a laser beam recorder (LBR) and with substrates having no pre-grooves. A radiation source 110, for example a semi-conductor laser, emits a diverging radiation beam 112. The beam 112 is made essentially parallel by a collimator lens 114, from which it is projected to a beam splitter 116. At least a part of the beam 118 is further projected to an objective lens 120 which focuses a converging beam 122 onto a master substrate 10. The master substrate 10 will be described in detail with reference to the Figures below. The focused beam 122 is able to induce a phase change in the recording layer of the master substrate. On the other hand, the converging beam 122 is reflected into a diverging beam 124 and is then projected further as an essentially parallel beam 126 by the objective lens 120. At least part of the reflected beam 126 is projected to a condenser lens 128 by the beam splitter 116. This condenser lens 128 focuses a converging beam 130 onto a detector system 132. The detector system 132 is adapted to extract information from the light projected onto the detector system 132 and to transform this information into a plurality of electrical signals 134, 136, 138, for example an information signal 134, a focus error signal 136 and a tracking error signal 138. With reference to the present invention, the tracking error signal 138 is of particular relevance. The localization of the converging beam 122 on the master substrate 10 is controlled via a pre-groove structure in the master substrate 10. The grooves in the master substrate 10 generate an optical tracking error signal. The resulting interference pattern is finally projected onto the detector system 132, and it is symmetric in case the beam is perfectly centered with respect to the groove. A difference signal, the so-called push-pull signal, is created on the basis of multiple detectors or multiple detector segments of the detector system 132. It is zero in the case of perfect centering of the beam with respect to the groove. A deviation from the central position will lead to more or less light on the generally two detector parts. The difference signal becomes non-zero, and it can be used to re-align the spot with respect to the groove.

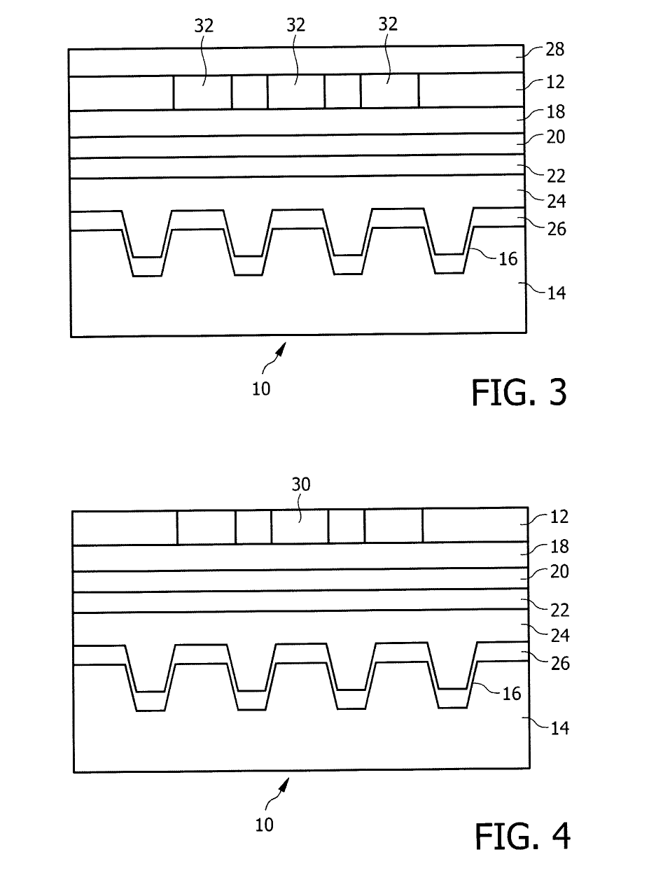

FIG. 2 shows a schematic cross section through a master substrate for being processed according to the present invention; FIG. 3 shows a schematic cross section through a further embodiment of a master substrate after partly being processed according to the present invention. Although the embodiments according to FIG. 2 and FIG. 3 are different, it is still possible to discuss them together. The embodiment according to FIG. 3 is more elaborate than the basic embodiment according to FIG. 2. On top of the master substrate 10 a protection layer 28 is provided. The protection layer 28 is made of a material that well dissolves in conventional developer liquids, such as KOH and NaOH. For example the protection layer 28 comprises of ZnS—SiO₂ or photoresist. The thickness of the protection layer 28 is between 5 and 100 nm, preferably between 10 and 25 nm. The protection layer is added to prevent large-scale migration of molten phase-change material under influence of centrifugal forces during rotation of the master substrate. The protection layer should be resistant to the high recording temperature of around 600-700° C. in case of amorphous writing. Furthermore, the protection layer should be removable to form the relief structure in the information layer and possibly in the interface layer I1 as well. The focused laser beam 122 is projected onto the protection layer 28. Underneath the protection layer 28 the recording layer 12 is arranged. The recording materials are preferably so-called fast-growth phase-change materials, preferably of the composition: SnGeSb (Sn_{18.3}—Ge_{12.6}—Sb_{69.2} (At %)) or Sb₂Te doped with In, Ge, etc, such as in InGeSbTe. These growth-dominated phase-change materials process a high contrast in dissolution rate of the amorphous and crystalline phase. The amorphous marks, obtained by melt-quenching of the crystalline material, can be dissolved in conventional developer liquids, such as KOH and NaOH, but also HCl and HNO₃. Re-crystallization in the tail of the mark can be used to reduce the marklength in a controlled way. Thereby it is possible to create marks with a length shorter than the optical spot size. In this way, the tangential data density can be increased. The data pattern thus written on the recording layer 12 can be transformed to a relief structure via etching. The thickness of the recording layer 12 is between 5 and 80 nm, preferably between 10 and 40 nm. Beneath the recording layer 12 a first interface layer 18 is provided. This interface layer 18 may be etchable as well. The patterned recording layer 12 then serves as a mask layer. The preferred material for the first interface layer 18 is ZnS—SiO₂. The thickness of the first interface layer 18 is between 5 and 80 nm, preferably between 10 and 40 nm. The first interface layer 18 is followed by a second interface layer 20 which is not etchable, and thus acts as a natural barrier. This second interface layer 20 is about 50 nm thick. Beneath the second interface layer 20 a semi-transparent metallic layer 22 is provided that serves as a heat-sink to remove the heat during recording. The metal heat sink layer is added to control the heat accumulation during writing of data and grooves. In particular, if marks are written by amorphisation of the phase-change material, it is important that heat is quickly removed from the information layer during recording to enable melt-quenching of the phase-change material. Semi-transparent metals, such as Al or Ag, or transparent heat-sink layers, such ITO or HfN, are proposed. The preferred thickness of the heat-sink layer 22 is between 5 and 40 nm. Below the heat-sink layer 22 and above the substrate 14 a leveling layer 24 is provided to level out the pre-grooves such that a planar recording stack remains. The leveling layer 24 is deposited via a spincoat process, or other type of process that enables filling of the grooves. The material for the leveling layer is preferably a non-absorbing, spincoatable organic material. The lowermost layer is the already mentioned substrate layer 14 that, according to the embodiment of FIG. 3, contains pre-grooves 16 for tracking purposes. In order to enhance the tracking error signal, a reflective layer 26 is deposited on the substrate layer. On the basis of these pre-grooves the mastering, generally performed on an LBR, may be carried on a conventional optical disc drive.

With reference to FIG. 3, recorded marks 32 have been generated in the recording layer 12. These recorded marks 32 are amorphous areas with crystalline areas in between. The recorded marks 32 and the protection layer 28 are subsequently dissolved in conventional etch liquids, such as NaOH or KOH to end up with a high-density relief structure. This high-density relief structure 30 is shown in FIG. 4.

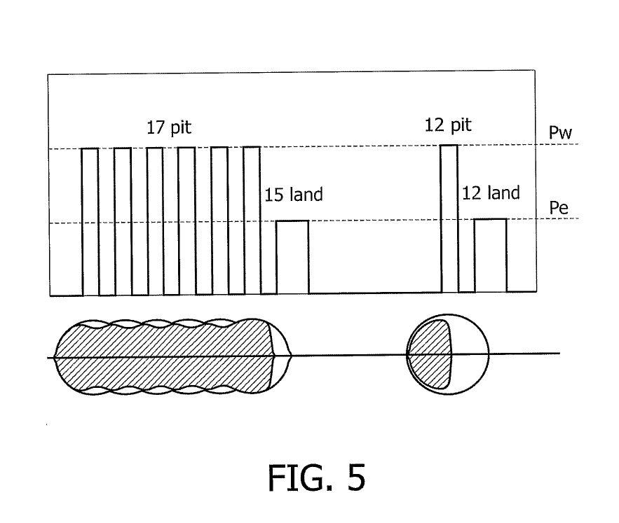

FIG. 5 shows a pulse diagram for illustrating an embodiment according to the present invention. The fundamental aspects of the write strategy according to the present invention are explained with reference to the N−1 write strategy, in which a NT long mark/pit is written with N−1 write pulses. The Figure also shows the targeted mark pattern. The amorphous mark prior to etching, which will lead to a pit after etching, is written with 6 write pulses. An I2 pit, which is generated on the basis of the smallest mark, is written with one write pulse. The trailing edges of the pits/marks are shaped via re-crystallization, which is induced by the applied erase pulse. The erase pulse is just long enough to cause the required re-crystallization. The erase pulse is followed by a cooling gap to limit the heat accumulation in the recording stack.

The heat accumulation in the recording stack is determined by the total laser energy being absorbed, the direct heating term, and the ease of diffusion through the stack. In case of conventional phase-change recording, the erase periods are required to erase the old amorphous marks present in the disc to obtain the crystalline lands (so-called direct overwrite of data, DOW). These intermediate erase periods cause a higher DC-kind of temperature distribution, on which the write pulses are superimposed. Therefore, the temperature achieved in the adjacent track is higher, thereby causing more re-crystallization of the amorphous marks present in the adjacent track, hence thermal cross-write. In particular if the data track pitch, i.e. the distance between two subsequent data tracks, is too small, heating of the adjacent tracks deteriorates the present data marks.

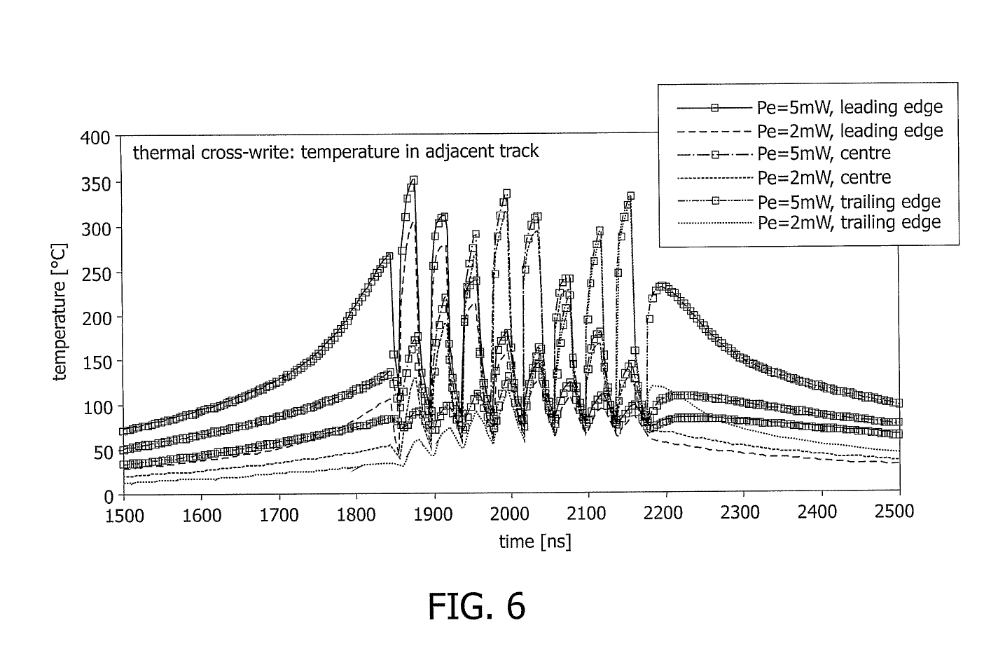

FIG. 6 shows a temperature-time diagram for explaining the thermal cross-write effect. In this Figure the temperature-time responses in the adjacent track at a distance of 200 nm due to writing of an 8 T mark in the central track for two erase power levels are shown. The distance of 200 nm corresponds roughly to the edge of the marks in the adjacent track. The profiles are plotted at three locations in the mark, namely the leading part, the center part and the trailing part of the mark. Obviously, the higher erase power level of 5 mW leads to higher temperature over a longer time, thereby inducing more re-crystallization of the present marks. The calculations illustrate that the replacement of the erase periods with short erase bumps to shorten the marks in the central track is beneficial to suppress the thermal cross-write effect.

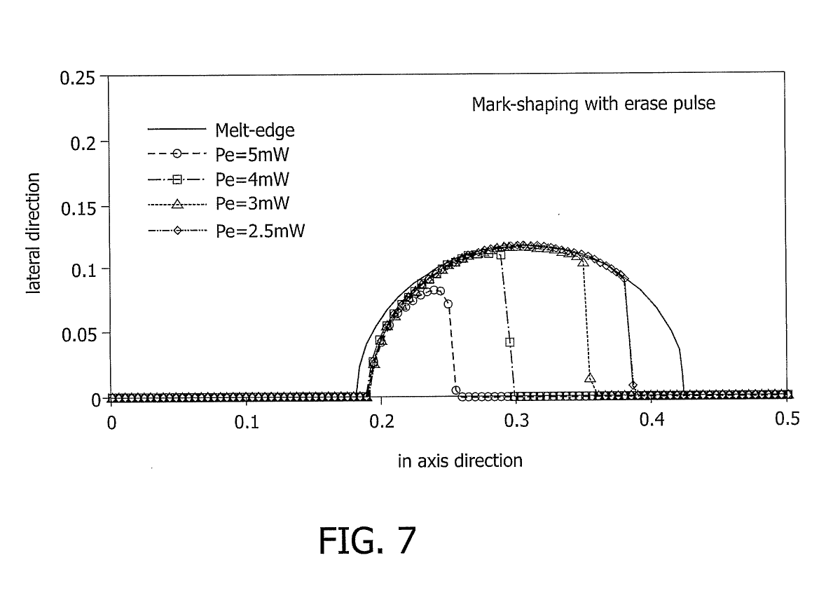

FIG. 7 shows model calculations for illustrating the controlled re-crystallization. The controlled re-crystallization in the tail of the mark for shaping purposes can be enabled by adjusting the erase power level, the duration of the pulse and the time between the last write pulse and the erase bump, thereby providing a cooling gap. Computer simulations of the mark shape after controlled re-crystallization of an I2 mark due to a variation of the erase power of the erase bump are given in FIG. 7. The write power was 7 mW, the erase bump had a power between 2.5 and 5 mW. The solid line indicates the molten area, the symbols indicate the mark after partial re-crystallization. In this example, a significant reduction of the tangential mark size was achieved by increasing the erase power. This controlled re-crystallization can also be achieved by a longer erase bump or a shorter cooling gap between the erase bump and the last write pulse. The re-crystallization of the trailing edge of the amorphous mark can also be achieved by an extension of the last write pulse in the pulse trail. This is, however, less preferred, since the extended write pulse will cause re-crystallization from the sides of the marks as well, leading to a less well defined pit.

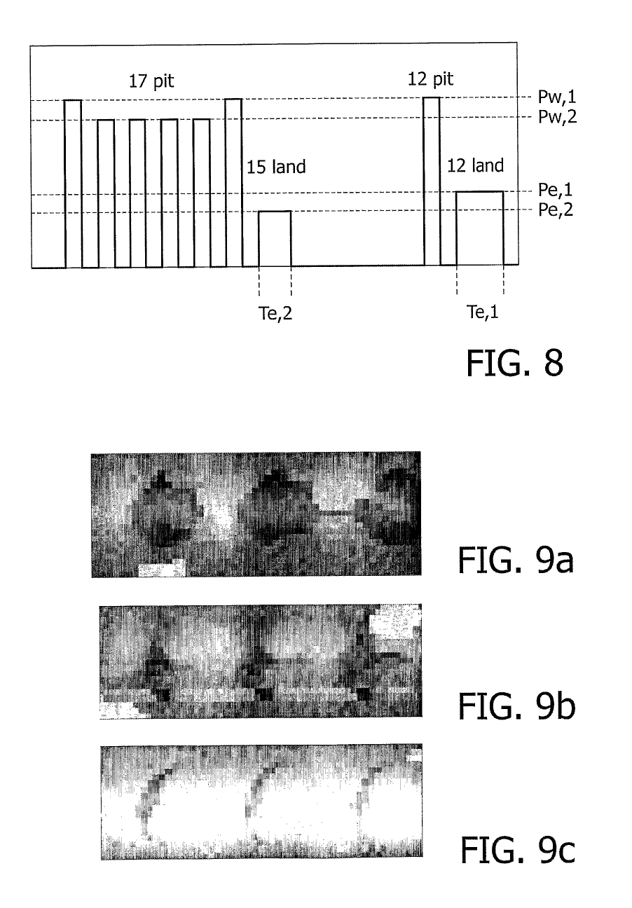

FIG. 8 shows a pulse diagram for illustrating an embodiment of the present invention. This write strategy is modified as compared to the write strategy according to FIG. 5. The write power for writing the small and longer marks is different. This is indicated with Pw,1 and Pw,2. The erase pulse to shape the trailing edge of the short mark has a higher power and longer duration to induce more re-crystallization, indicated with Pe,1 and Te,1 and Pe,2 and Te,2. Even if the amount of re-crystallization is the same, the achieved temperature will be lower in case a short mark is written. Therefore, an extended erase pulse of higher write power is preferred to shape the tail of a short mark. Note, that also the power levels within the longer pulse train are different, so that a further parameter for influencing the shape of the marks is provided.

FIG. 9 shows pictures from an atomic force microscope (AFM pictures) of a data patterns consisting of 2 T pits that are separated by 2 T spaces (lands): (a) Te=Tp; (b) Te=2Tp; (c) Te=3Tp. An erase pulse of 0.5 Pw and variable pulse length is applied. The duration of the erase pulse (Te) was similar to the write pulse length (Tp) in FIG. 9a. In FIG. 9b the erase pulse is twice as long. Results for a three times longer erase pulse are given in FIG. 9c. An elongated erase pulse leads to more re-crystallization and therefore to shorter 2 T marks. It is further noticed that the induced back-growth is very reproducible.

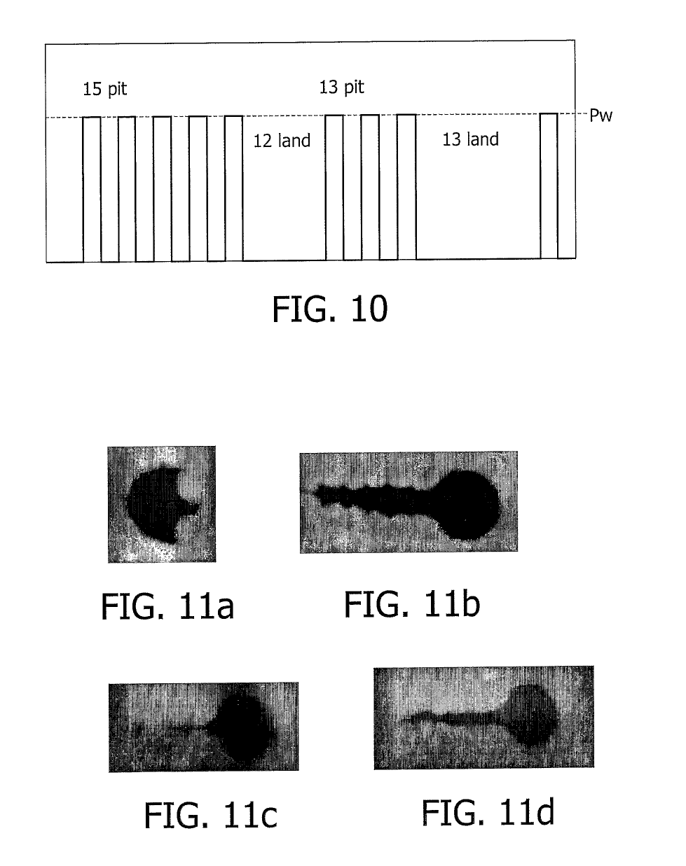

In the following embodiments (FIGS. 10-19) only the write pulse sequences are depicted. The erase bump as described in FIG. 5 and detailed in FIG. 8 can be applied to all described write strategies to enable the controlled re-crystallization in the tail of the mark.

FIG. 10 shows a pulse diagram for illustrating an embodiment according to the present invention. FIG. 11 shows pictures from an atomic force microscope (AFM pictures). According to the N-strategy, an NT long mark/pit is written with N write pulses. The write power can be varied to obtain wider marks. FIG. 11a shows an I2 pit with re-crystallization which is well-shaped by the controlled re-crystallization in the tail of the mark. Figures b and c show an I7 pit written with moderate power (40 ILV), FIG. 11d shows an I7 pit written with 45 ILV. The recording velocity was 2 m/s. The three FIGS. 11b, 11c, and 11d show that severe re-crystallization occurred during writing of data. The used material was too fast for the recording velocity of 2 m/s. A higher recording velocity would improve the mark formation.

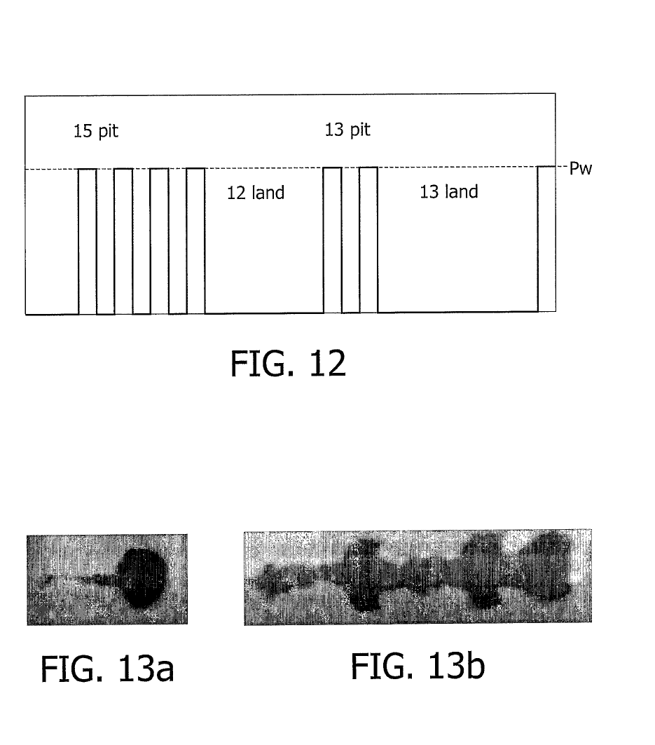

FIG. 12 shows a pulse diagram for illustrating an embodiment according to the present invention. FIG. 13 shows pictures from an atomic force microscope. According to the N−1 strategy, an NT long mark/pit is written with N−1 write pulses. The wider cooling gaps, between the write pulses, lead to less re-crystallization during write, as can be seen in FIG. 13a. This picture was achieved on the basis of a 6 T pit written with 50 ILV. In FIG. 13b, additionally, several marks written with 70 ILV that partially overlap each other are shown.

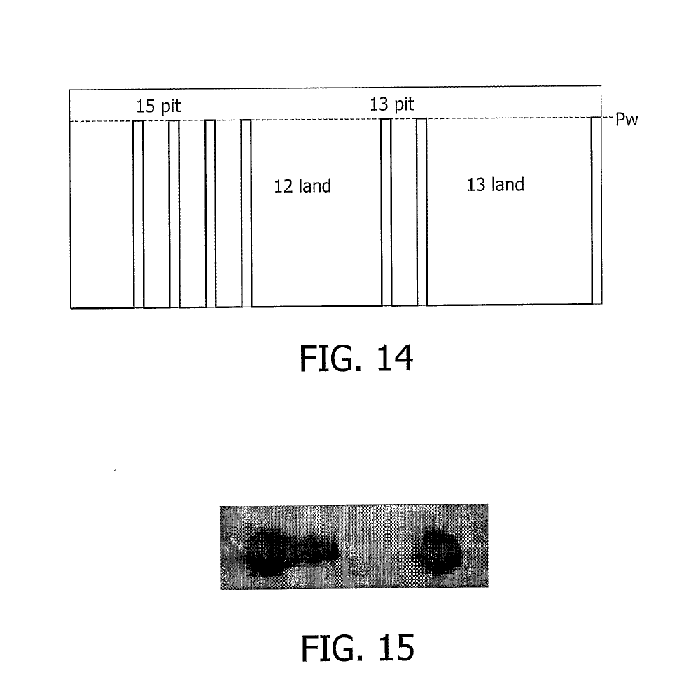

FIG. 14 shows a pulse diagram for illustrating an embodiment according to the present invention. In this embodiment, the N−1 strategy with shorter pulses as compared with the strategy according to FIG. 12 is explained. Longer cooling gaps are obtained in order to suppress the heat accumulation and to reduce the re-crystallization in the leading edge. A higher write power is required to write marks of the same width. FIG. 15 shows an AFM picture of a T2 and a T4 pit. The leading edge of the pit is almost as wide as the 2 T pit and clearly wider than the pit in FIG. 11a. An additional erase pulse can be used to partially re-crystallize the trailing edge in tangential direction, as explained with respect to FIG. 7. Generally, all of the embodiments explained without erase pulses can be modified by applying such erase pulses.

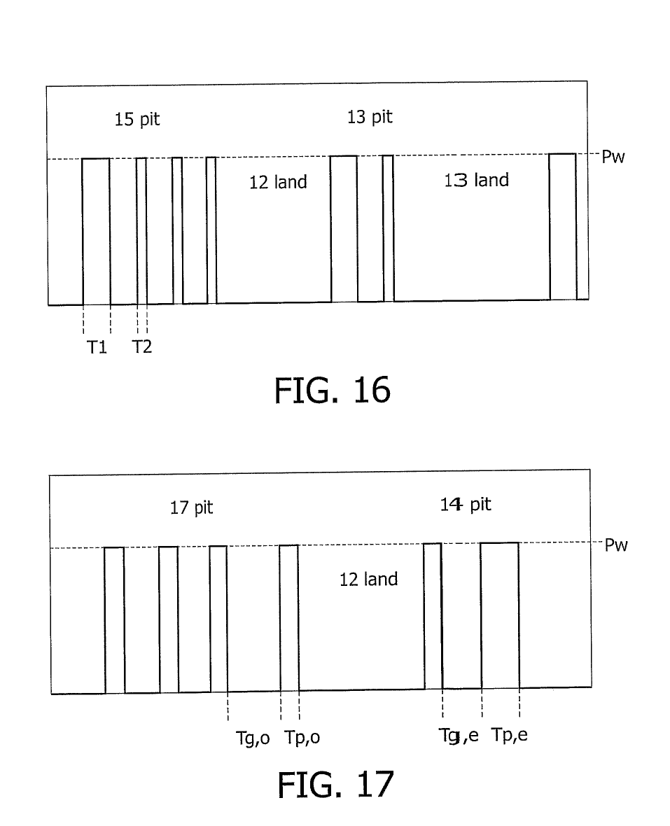

FIG. 16 shows a pulse diagram for illustrating an embodiment according to the present invention. According to the N−1 strategy with variable pulse lengths, an extension of the first write pulse will lead to a better defined leading edge. Length and power of the subsequent pulses may be varied to minimize re-crystallization during write. In the example shown, the first pulse is three times as long as the subsequent pulses. All pulses have equal write powers. The duration of the cooling gaps can also be varied to suppress re-crystallization.

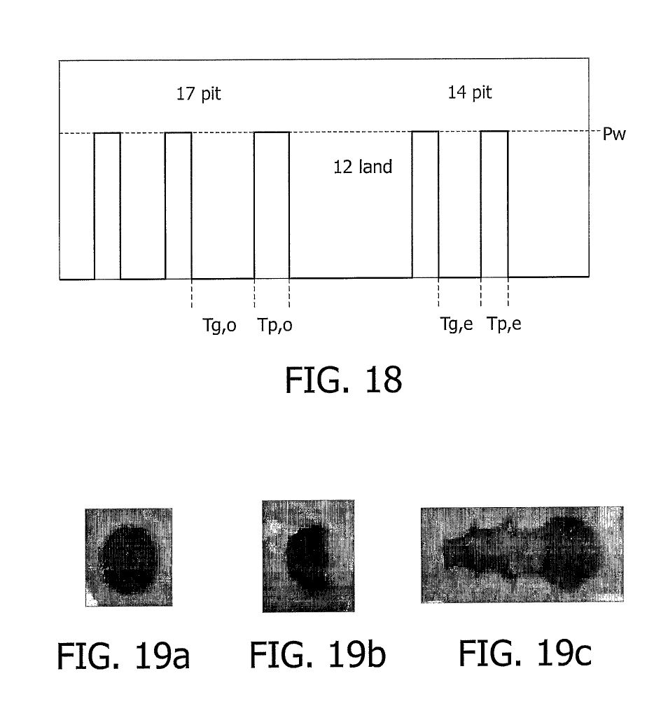

FIG. 17 shows a pulse diagram for illustrating an embodiment according to the present invention. FIG. 18 shows a further pulse diagram for illustrating an embodiment according to the present invention. FIG. 19 shows pictures from an atomic force microscope. According to the 2 T strategy shown in these Figures, an NT long mark/pit is written with N/2 write pulses. This write strategy reduces the heat accumulation in the recording stack and, therefore, suppresses re-crystallization during write. Such write strategies are well known for high-speed and dual-layer applications. A 7 T mark can be written with 3 or 4 pulses. In the examples according to FIG. 17 and FIG. 18, the lengths of the last pulses (Tp,o and Tp,e) and of the last cooling gap (Tg,o and Tg,e) are different for odd and even marks. In FIGS. 19a and b the growth-back of a T2 mark can clearly be seen. The T7 pit according to FIG. 19c is written with the pulse strategy according to FIG. 17. A wide leading edge is the result, thus re-crystallization has been suppressed.

Equivalents and modifications not described above may also be employed without departing from the scope of the invention, which is defined in the accompanying claims.

1. A method of writing data on a master substrate (10) for optical recording, the master substrate comprising a recording layer (12) and a substrate layer (14), and the recording layer comprising a phase-change material the phase of which can be transferred from crystalline to amorphous by projecting light on the recording layer, the method comprising the steps of:
writing a first amorphous mark (32) from a plurality of amorphous marks on the master substrate by at least one write pulse, and
providing a cooling gap before the next amorphous mark (32) will be written.

2. A method according to claim 1, wherein a plurality of write pulses is used for writing an amorphous mark, the write pulses having essentially the same power.

3. A method according to claim 1, wherein a plurality of write pulses is used for writing an amorphous mark, the write pulses having different power values.

4. A method according to claim 1, wherein, after the at least one write pulse, at least one erase pulse is applied, the erase pulse having a power less than the write pulse.

5. A method according to claim 4, wherein an erase pulse following a larger number of write pulses has a lower power than an erase pulse following a smaller number of write pulses.

6. A method according to claim 4, wherein the duration of an erase pulse is between 0.5 and 2.5 times the write pulse duration

7. A method according to claim 1, wherein a mark having a length of N times the channel bit length T is written by N write pulses.

8. A method according to claim 1, wherein a mark having a length of N times the channel bit length T is written by N−1 write pulses.

9. A method according to claim 1, wherein a mark having a length of N times the channel bit length T is written by N/2 write pulses.

10. A method according to claim 1, wherein the first write pulse from a plurality of write pulses is the longest write pulse.

11. A method according to claim 1, wherein cooling gaps of adjustable lengths are provided between write pulses belonging to the same amorphous mark.

12. A method according to claim 4, wherein a cooling gap of adjustable length is provided before the erase pulse.

13. A stamper for replicating a high density relief structure produced by a method according to claim 1.

14. A method of producing an optical data carrier using a stamper according to claim 13.
